(19) United States
(12) Patent Application Publication
(10) Pub. No.: US 2005/0244212 A1
(43) Pub. Date: Nov. 3, 2005

(54) Foam generating article

(75) Inventors: Michael S. Brunner, Roswell, GA (US); Nefetari Murph, Tucker, GA (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/881,519

(22) Filed: Jun. 30, 2004

Related U.S. Application Data
(63) Continuation-in-part of application No. 10/844,568, filed on Apr. 30, 2004.

(51) Int. Cl. B43K 5/00; B43K 8/02

(52) U.S. Cl. 401/196

(57) ABSTRACT

In one embodiment, a foam generating article comprises: a first layer comprising a gas generating composition and a second layer disposed on a first side of the first layer. The second layer comprises a first surfactant and has a plurality of second layer pores with a second pore size sufficient to form bubbles upon the generation of the gas. In another embodiment, the foam generating article comprises: a first layer comprising a gas generating composition, and a second layer disposed on a first side of the first layer, wherein the second layer comprises a first surfactant. The first layer comprises less than or equal to about 5 wt % of all surfactant in the article.

### CROSS REFERENCE TO RELATED APPLICATIONS

The present application is a continuation-in-part application of U.S. patent application Ser. No. 10/844,568, Attorney Docket No. KC #18430, filed Apr. 30, 2004, and entitled “Activatable Cleaning Products”, which is hereby incorporated herein in its entirety.

### BACKGROUND

Various products are commercially available with releasable active materials within a structure, wherein a reactive chemical in the structure induces the release of a material upon the application of a force (e.g., causing the chemicals to mix and a reaction to occur). The releasable materials in the articles can include materials to assist in the effectiveness of the article; e.g., water, emollients, and/or surfactants, can be included in the article. The application of a force to cause a desired chemical reaction, however, can damage the article, and is generally undesirable.

There remains a need for convenient foam generating articles, and particularly for foam generating articles that do not require mechanical action for the generation of foam.

### BRIEF SUMMARY

Disclosed herein are foam generating articles, a packaged disposable cleaning product comprising a foam generating article, as well as methods for making and using the same. In one embodiment, a foam generating article comprises: a first layer comprising a gas generating composition, and a second layer disposed on a first side of the first layer. The second layer comprises a first surfactant and has a plurality of second layer pores with a second pore size sufficient to form bubbles upon the generation of the gas.

In another embodiment, a packaged disposable cleaning product comprising a foam generating article, comprises: a first layer comprising a gas generating composition, and a second layer disposed on a first side of the first layer, wherein the second layer comprises a first surfactant. The first layer comprises less than or equal to about 5 wt % of all surfactant in the article.

The above described and other features are exemplified by the following figures and detailed description.

### BRIEF DESCRIPTION OF DRAWINGS

Refer now to the figures, which are exemplary, not limiting, and wherein like elements are numbered alike.

FIG. 1 is a perspective view of a foam generating article that has a first layer comprising a gas generating composition and a second layer comprising a first surfactant.

FIG. 2 is a perspective view of a foam generating article in accordance with one embodiment of the disclosure that has a barrier disposed on the first layer.

FIG. 3 is a perspective view of a foam generating article in accordance with one embodiment of the disclosure that has a third layer comprising a second surfactant.

FIG. 4 is a perspective view of a foam generating article in accordance with one embodiment of the disclosure that has a third layer comprising a barrier.

### DETAILED DESCRIPTION

Disclosed herein a packaged disposable cleaning product, e.g., a sealed product (such as a pouch, sachet, an article with an enclosed cavity (e.g., a layered article, an non-layered article with a gas generating composition disposed therein), and so forth). The product comprises a foam generating article that can comprise a first layer comprising a gas generating composition and a second layer comprising a surfactant, wherein the “layers” can be separate layers and/or can be portions of the article (e.g., the first layer can be the gas generating composition that is in an enclosed cavity in the second layer and/or a cavity between the second layer and a third layer). The second layer has a plurality of second layer pores with a second pore size sufficient to form bubbles upon generation of gas. All ranges disclosed herein are inclusive and combinable (e.g., ranges of “up to about 25 wt %, or, more specifically about 5 wt % to about 20 wt %” is inclusive of the endpoints and all intermediate values of the ranges of “about 5 wt % to about 25 wt %,” etc.). The terms “first,” “second,” and so forth, herein do not denote any order, quantity, or importance, but rather are used to distinguish one element from another, and the terms “a” and “an” herein do not denote a limitation of quantity, but rather denote the presence of at least one of the referenced item.

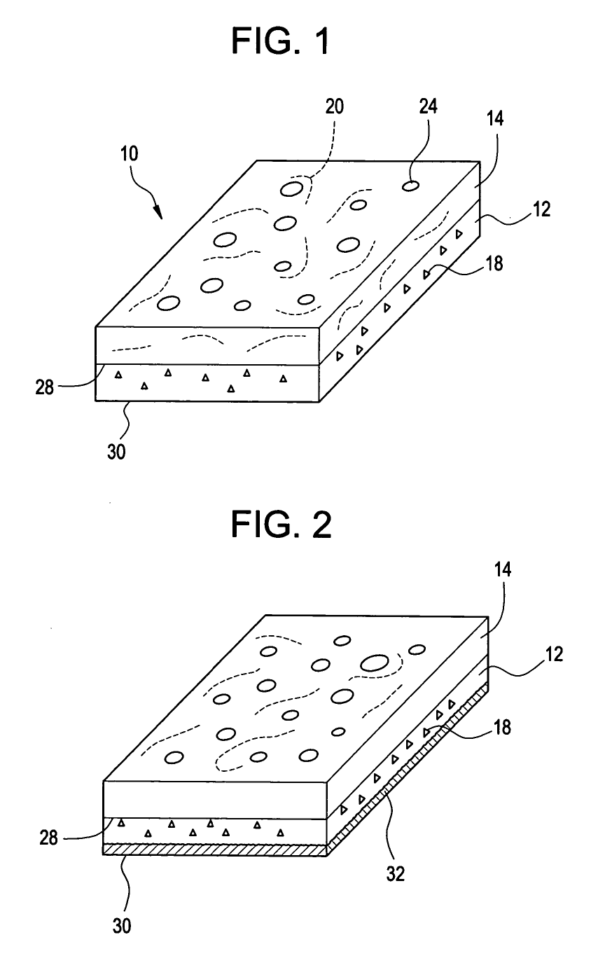

Referring now to FIG. 1, in one embodiment, a foam generating article 10 comprises a first layer 12 comprising a gas generating composition 18, with a second layer 14 disposed on a first side 28 of the first layer 12. The second layer 14 comprises a first surfactant 20 and has a plurality of second layer pores 24 with a pore size (referred to herein as a second pore size) sufficient to form bubbles upon the generation of the gas. Optionally, a barrier 32 can be disposed on a second side 30 of first layer 12. (See FIGS. 2 and 4) Alternatively, or in addition, the foam generating article, can further comprise a third layer 16. The third layer 16 can be disposed between the first layer and an optional barrier layer 32 such that the second side 34 of the barrier layer 32 forms an external surface of the article. (See FIG. 4) If the texture of the article is a factor, for example, the third layer 16 (or a fourth layer, not shown) can be disposed on the second side 34 of the barrier layer 32 such that the barrier layer 32 is disposed between the first layer 12 and the third layer 16 (or the fourth layer, respectively). The third layer 16 may optionally comprises a second surfactant 22 (e.g., emollient(s), acidic material(s), alkaline material(s), preservative(s), chelating agent(s), pH buffer(s), fragrance(s), lotion(s), medicant(s), abrasive(s), antibacterial(s), fungicide(s), skin benefit agent(s) (e.g., anti-wrinkle formulation(s), anti-aging formulation(s), skin lightener(s), self-tanning agent(s), acne inhibitor(s)/treatment(s), and so forth), sunscreen(s), and so forth, as well as combinations comprising at least one of the foregoing).

The surfactants 20,22 may individually be a single surfactant or a mixture of two or more surfactants. If a mixture of two or more surfactants is employed, the surfactants may be selected from the same or different classes, provided only that the surfactants present in the mixture are compatible with each other. The surfactant is suitably selected from the group consisting of anionic, cationic, nonionic, zwitterionic, and amphoteric surfactants, and combinations comprising at least one of the foregoing surfactants. Examples of anionic surfactants include, but are not limited to, linear and branched-chain sodium alkylbenzene sulfonates; linear and branched-chain alkyl sulfates; linear and branched-chain alkyl ethoxy sulfates; and silicone phosphate esters, silicone sulfates, and silicone carboxylates; and so forth, as well as combinations comprising at least one of the foregoing. Examples of cationic surfactants include, but are not limited to, tallow trimethylammonium chloride, silicone amides, silicone amido quaternary amines, silicone imidazoline quaternary amines, and so forth, as well as combinations comprising at least one of the foregoing. Examples of nonionic surfactants include, but are not limited to, alkyl polyethoxylates; polyethoxylated alkylphenols; fatty acid ethanol amides; dimethicone copolyol esters, dimethiconol esters, and dimethicone copolyols; and complex polymers of ethylene oxide, propylene oxide, and alcohols; and so forth, as well as combinations comprising at least one of the foregoing.

Examples of amphoteric surfactants include, but are not limited to, aliphatic secondary and tertiary amines, especially wherein the nitrogen is in a cationic state, in which the aliphatic radicals can be straight or branched chain and wherein one of the radicals contains an ionizable water solubilizing group such as carboxy, sulphonate, sulphate, phosphate, phosphonate, and so forth, as well as combinations comprising at least one of the foregoing. Useful substances include, but are not limited to, cocamidopropyl betaine, cocamphoacetate, cocamphodiacetate, cocamphopropionate, cocamphodipropionate, cocamidopropyl hydroxysultaine, cetyl dimethyl betaine, cocamidopropyl PG-dimonium chloride phosphate, coco dimethyl carboxymethyl betaine, cetyl dimethyl betaine, and so forth, as well as combinations comprising at least one of the foregoing.

The second layer 14, and optionally the third layer, can comprise the first surfactant 20 in an amount of about 0.05 grams per square meter (g/m²) to about 5 g/m², or, more specifically in an amount of about 0.1 g/m² to about 1 g/m², or, even more specifically in an amount of about 0.25 g/m² to about 0.75 g/m². In one embodiment, the first layer 12 further comprises less than or equal to about 10 weight percent (wt %), or, more specifically, less than or equal to about 5 weight percent, or, even more specifically less than or equal to about 1 weight percent, and even more specifically, no added surfactant, based on a total combined weight of the gas generating composition and surfactant(s) in the first layer. Due to the design of the present article, a weight ratio of surfactant to gas generating composition in the entire article can be less than or equal to about 1:10, or more specifically, less than or equal to about 1:100.

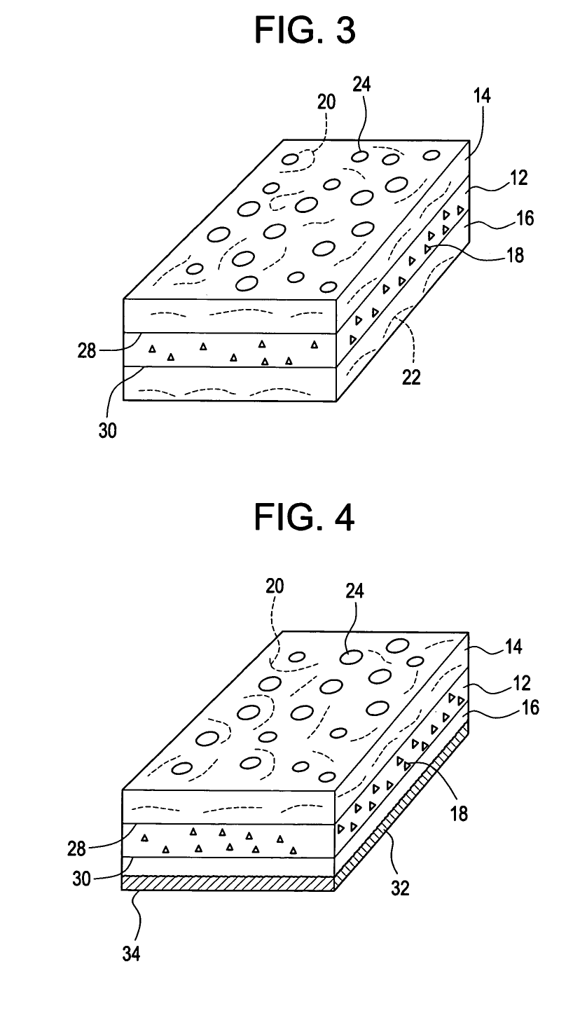

Optionally, the third layer 16 can have a plurality of third layer pores with a pore size sufficient to form bubbles upon generation of the gas. (See FIG. 3) Where both a barrier 32 and a third layer are employed, the barrier 32 can optionally be disposed between the first layer 12 and the third layer 16.

The gas generating composition 18 generates a gas (e.g., carbon dioxide, nitrogen, oxygen, and/or so forth) upon contact with a reactant, e.g., water, acid, peroxide, or so forth, as well as combinations comprising at least one of the foregoing reactants. For applications such as wipes, paper towels, sponge, cleaning pads, replaceable cleaning head, gloves, mitts, sheets, makeup pads, cloths, and so forth, as well as combinations comprising at least one of the foregoing applications, employing water enables sale of the article without the reactant. During use, the article would be contacted with water (e.g., placed in a bucket of water, held under running water in a sink, or otherwise contacted with water) to initiate the foam generation. As the reactant (e.g., water) contacts the gas generating composition 18, gas is generated. The gas passes through the openings in the second layer 14, contacting the surfactant 20, and forming a foam.

Exemplary gas generating compositions comprise, but are not limited to, an acid material, an alkaline material (such as salts of carbonates and bicarbonates), alkaline peroxides (e.g., sodium perborate and sodium percarbonate), azides (e.g., sodium azide), and so forth, as well as combinations comprising at least one of the foregoing materials. Some exemplary gas generating compositions as well as other materials (e.g., the surfactant(s)) can be found in U.S. Pat. No. 6,063,390.

Possible acid materials include, but are not limited to, C₂-C₂₀ carboxylic acids, organophosphorus acids, and organosulfur acids; and peroxides such as hydrogen peroxide; polyacrylates (e.g. encapsulating polyacrylic acid), cellulosic gums, polyurethane, and polyoxyalkylene polymers. Typical hydroxycarboxylic acids include, but are not limited to, adipic, glutaric, succinic, tartaric, malic, maleic, lactic, salicylic, and citric acids, acid forming lactones (such as gluconolactone and gluccrolactone), and so forth, as well as combinations comprising at least one of the foregoing. Concentrations of the acid can be about 10 wt % to about 90 wt %, or more specifically, about 30 wt % to about 70 wt %, and even more specifically, about 40 wt % to about 60 wt %, based upon a total weight of the gas generating composition.

Optionally, the first layer 12 can comprise a time release agent. The time release agent enables the gas generating composition 18 to generate a gas over a predetermined period of time. Suitable time release agents include, but are not limited to, polyacrylate(s), cellulosic gum(s), polyurethane(s), polyoxyalkylene(s), and so forth, as well as combinations comprising at least one of the foregoing. The time release agent can encapsulate at least a portion of the gas generating composition. In one embodiment, a gas is generated over a period of time of about 1 minute to about 30 minutes, or so, or, more specifically, about 2 minutes to about 10 minutes, or even more specifically, over a period of about 3 minutes to about 5 minutes.

The barrier 32, which can be a coating and/or the layer itself, can be designed to inhibit the generated gas from flowing through the barrier. This barrier can merely have a higher resistance to the passage of the gas than the second layer 14 (e.g., a smaller pore size, or, more specifically, a pore size of less than 0.25 mm). For example, the resistance can be a sufficient resistance to allow the passage of less than or equal to about 10 wt % of the generated gas, or more specifically, less than or equal to about 5 wt %, and even more specifically, less than or equal to about 1 wt %, desirable. In one embodiment, the barrier 32 can be a barrier coating, barrier layer, or so forth. An exemplary barrier 32 is a reactive acrylic latex with carboxyl functionality, which cures to provide a crosslinked acrylic resin.

The foam generating article may further comprise a skin benefit agent selected from the group consisting of emollients, anti-aging actives, antibacterials and fungicides, skin lighteners, sunscreens, and combinations comprising at least one of the foregoing. Exemplary skin benefit agents include, but are not limited to, the skin benefit agents described in U.S. Pat. No. 6,217,854 to Farrell et al.

The materials used to form the layers of the foam generating article 10 may vary depending on the intended use of the foam generating article. In one embodiment, the layers, individually, comprise natural fibers, synthetic fibers, and combinations comprising at least one of the foregoing materials. These fibers can be formed into woven or non-woven fabric(s) and/or web(s). Examples of natural nonwoven fibers include, but are not limited to, silk fibers, keratin fibers, cellulosic fibers, and individually selected from the group consisting. Some exemplary keratin fibers include, but are not limited to, wool fibers, camel hair fibers, and so forth, and combinations comprising at least one of the foregoing fibers. The cellulosic fibers include, but are not limited to, wood pulp fibers, cotton fibers, hemp fibers, jute fibers, flax fibers, and so forth, as well as combinations comprising at least one of the foregoing fibers.

The synthetic nonwoven fibers, which can include, but are not limited to, mono-component and/or multi-component fibers, can, for example, be formed from a variety of thermoplastic fibers such as acetate fibers, acrylic fibers, cellulose ester fibers, modacrylic fibers, polyamide fibers, polyester fibers, polyolefin fibers, polyvinyl alcohol fibers, rayon fibers, and so forth, as well as combinations comprising at least one of the foregoing thermoplastic fibers, and fibers comprising copolymers comprising at least one of the foregoing materials. Suitable thermoplastic fibers include, but are not limited to, acrylic fibers (e.g., acrylonitrile-based fibers, and so forth); cellulose ester fibers (e.g., such as cellulose acetate, and so forth); polyamides (such as nylon 6, nylon 66, nylon 610, and so forth); polyester fibers (such as polyethylene terephthalate fibers, polybutylene terephthalate fibers, and so forth); polyolefin fibers (such as polypropylene fibers, polyethylene fibers, and so forth); polyvinyl acetate fibers; and so forth, as well as combinations comprising at least one of the foregoing fibers.

The layers can be adhered together in various fashions, such as thermal bonding (e.g., pattern bonded), ultrasonically, adhesively (e.g., adhesive, resin, and/or latex impregnation, painting, spraying, and/or so forth), and/or mechanically (e.g., through-air dried) bonded. For instance, various techniques are described in U.S. Pat. No. 3,855,046 to Hansen; U.S. Pat. No. 5,620,779 to Levy et al.; U.S. Pat. No. 5,962,112 to Haynes et al.; U.S. Pat. No. 6,093,665 to Sayovitz et al.; U.S. Des. Pat. No. 428,267 to Romano et al.; U.S. Des. Pat. No. 390,708 to Brown; U.S. Pat. No. 5,284,703 to Everhart et al.; U.S. Pat. No. 6,103,061 to Anderson et al., and U.S. Pat. No. 6,197,404 to Varona. For example, the layers comprising the nonwoven fibers can be bonded by continuous seams or patterns. As additional examples, the nonwoven web can be bonded along the periphery of the sheet or simply across the width or cross-direction (CD) of the web adjacent the edges.

The layers comprising the nonwoven fibers may also be imparted with texture on one or more of its surfaces. The type and amount of texture can be based upon the final application of the article (e.g., for the application of an emollient to the skin, for cleansing and exfoliation of the skin; for cleaning a floor/counter/wall; for cleaning porcelain, plastic, tile, granite, glass, etc.; and so forth). Exemplary techniques for forming textured spunbond or meltblown materials are described in U.S. Pat. No. 4,659,609 to Lamers et al. and U.S. Pat. No. 4,833,003 to Win et al.

Depending upon the application of the article, an abrasive material may be disposed on one or more of the outer surfaces of the article (e.g., coated on the outer surface(s)) to facilitate cleaning. For example, the abrasive material on the foam generating article 10 enables the article to produce a mild scrubbing action on the skin and thus aid in the removal of ingrained soils, while not harming the skin by scratching. Optionally, the abrasive material can be in a particulate form, with a particle size of about 10 micrometers to about 2,000 micrometer, or, more specifically of about 50 to about 1,000 micrometer, or, even more specifically of about 100 to about 500 micrometer. Abrasive materials of other physical form, for example, fibers, may also be used.

In one embodiment, the foam generating article 10 can have an abrasive material on one side (e.g., on one outer layer surface), while the opposite side can have a smooth surface, e.g., to aid in wiping, in the removal of the foam and/or abrasive, and/or to apply a different composition to the surface being cleansed (e.g., to the skin). For example, during use, the one side of the foam generating article can be contacted with water such that a foam is generated through the side contacted with the water, generating a foam comprising an abrasive and/or cleanser. The second side of the foam generating article can comprise a barrier between the outer layer and the foam generating layer such that the generation of foam on the second side is inhibited. The second side can comprise emollient(s), lotion(s), chelating agent(s), pH buffer(s), fragrance(s), medicant(s), and/or so forth.

The application of the materials on the layers may be carried out before or after the layers are bonded. The ingredients may be coated on the surface of the layers or impregnated within the layers. In one embodiment, the gas generating composition 18 is sprayed or coated on the first layer 12. The first layer 12 is then bonded to the second layer 14 coated with the first surfactant 20. In one embodiment, in order to enhance foaming, the first surfactant is coated on a side of the second layer opposite the first layer 12. This may be carried out as a continuous process, using, for example, roller coating to apply the materials, and hot rollers to bond the two layers by thermal bonding. In one embodiment, the third layer is coated with a surfactant and then bonded to the second side of the first layer, again with the surfactant on a side of the third layer distal from the first layer.

The ingredients can be disposed on/in the layer(s) via a non-aqueous medium, if water will activate the foaming. For example, the ingredients, in a dry form, can be placed into a dry mill or similar apparatus and blended until a uniformly distributed powder results. The dry powder can then be disposed on the nonwoven fibers. The dry particles may be disposed on the fibers using an adhesive. Useful adhesives for this purpose include, but are not limited to, thermoplastic adhesive(s) (e.g., ionomer adhesive(s) such as a zinc salt of ethylene methacrylic acid copolymer), and so forth, as well as combinations comprising at least one of the foregoing. Alternatively, or in addition, the dry ingredients (e.g., in a powdered form) can be disposed on the layer(s) (e.g., on the fibers) with pressure (e.g., pressing the ingredients into the nonwoven material, such as when the ingredients are in a softened state).

Pre-pored layers may be used where the adhesion of the layers together (and/or application of a design to the layers) does not adversely affect the formation of foam through the layer, when the foaming will be produced through that layer. Optionally, the layers may be pored post adhering the layers together. The pores can be natural pores due to the non-woven material configuration and/or due to perforating or otherwise forming pores through the second layer (e.g., the layer through which the generated gas will flow). The size of the pores is sufficient to enable the formation of bubbles upon generation of a gas and desirably sufficient to inhibit the formation of a gas chamber between the gas generating layer and the layer having the pores (e.g., the gas passes through the pores and does not cause debonding of the layers, forming a gas chamber). Any porous layer through which bubbles are intended to be generated (e.g., second layer 20, and optionally third layer 22, etc.) can have, for example, an average diameter of about 0.5 millimeters (mm) to about 10 mm, measured along a major axis, or, more specifically about 1 mm to about 5 mm, and even more specifically, about 2 mm to about 3 mm.

The disclosure is further illustrated by the following non-limiting examples, illustrating compositions and methods of producing foam generating ingredients.

### EXAMPLE 1

A pouch was formed by folding a non-woven on itself and sealing 2 edges with hot melt adhesive. The non-woven was a textured wire hydro-knit nonwoven (the nonwoven looked similar to gauze) having 1 mm by 2 mm openings. Crushed Alka-Seltzer® tablet was placed inside the pouch, with the 4^{th} side closed with an adhesive seal. Soapy water was poured onto the pouch (I part soap per 100 parts by weight water). Foam was generated and the pocket expanded. Although the foam could be squeezed out of the pocket through the pores by pressing on the packet, the gas did not pass through the pores to generate a foam on an external surface, without exerting stress onto the pouch.

### EXAMPLE 2

Two Alka-Seltzer® tablets were crushed into a powder (weight=6.3 grams). The powder was mixed in a plastic beaker with 6.4 grams of granular laboratory detergent. Approximately half of the mixture was placed onto the surface of a very open structure nonwoven and worked into the surface of the structure. With a syringe, 15 milliliters (ml) of tap water was added to the nonwoven. Foam, about 1 centimeter (cm) thick, was generated immediately. Although this structure generated foam, the detergent interfered with the gas generation, thereby requiring a large amount of the gas generating composition and detergent.

### EXAMPLE 3

Alka-Seltzer® powder was prepared as described above and was sealed between a wet wipe (that had been dried at room temperature) and a thermoplastic film. Liquid dish soap was applied to wet wipe. Water was then added to activate the gas generating chemistry. Instead of generating a foam as expected, the CO₂ gas generated inflated the article like a balloon. The gas did not pass through the wet wipe to generate the foam. This same, undesirable phenomenon was observed using other film/substrate pouch type products. Substrates that were evaluated included a paper towel, a bonded carded web, a coform, and writing paper. It was determined that the pore size of the second layer affects the ability to generate the desired foam.

### EXAMPLE 4

A gas generating composition (e.g., a powered citric acid with a powder bicarbonate) can be applied to a non-woven structure such as with adhesive or other bonding technique. A surfactant can be applied to an outer surface of a 2 to 5 mm pore layer to form a surfactant layer. The non-woven layer can then be bonded to the inside surface of the surfactant layer with an adhesive, thermal bonding, and/or so forth, with a barrier layer optionally bonded to a side of the non-woven layer opposite the surfactant layer.

The foam generating article may be used in various applications including, but not limited to, personal care, household care, marine vehicle care, automotive care, animal care, medical products, and so forth. The article can be a packaged disposable cleaning product with a gas generating composition disposed within the article. For example, the article can comprise an enclosed cavity(ies). Some exemplary products include, but are not limited to, cleansing pad(s) (e.g., cosmetic, medical, and so forth), cleaning product(s) (e.g., a sponge with the gas generating composition disposed (e.g., injected, and/or so forth) in the sponge in one or more locations; a mop with the gas generating composition disposed within the strands of the mop (e.g., sealed within one or more layered strands forming the mop); a sheet that can be used alone and/or a sheet that attaches to the end of a handle (such as onto a head) for cleaning walls, floors, and so forth, wherein the sheet has the gas generating composition disposed within the sheet; and so forth), animal grooming product, and so forth.

The foam generating article when contacted with water may be used as cleaning articles for soaking, loosening, and removing stains without the need for scrubbing. The foam generating article may be effective in cleaning hard surfaces, as well as softer surfaces such as fabrics and carpet. The foam generating article may also be designed to clean the skin of a user. In one embodiment, the foam generating article may be used as an article generating foam over a predetermined period of time, when contacted with water.

Foaming articles have required the user to apply pressure to the article (e.g., twist, squeeze, stretch, compress, snap, fold, etc.) to generate foam. Such a feature can be undesirable. With the foam generating article disclosed herein, generation of the foam can be accomplished merely by contacting the foam generating article with a reactant (e.g., water). For example, foam generation occurs upon contact with an activator (e.g., water). The activator passes through an outerlayer to the foam generating layer where gas is generated. The gas passes through the outerlayer, contacting the surfactant, and generating a foam. The foam generation can be independent of the application of pressure.

Additionally, when the foam generating ingredients are in a pouch or a sachet, the surfactant can act as a barrier to the generated gas, thereby causing the pouch to inflate like a balloon when the gas is generated, or inhibiting the gas generation. Also, when the foam generating ingredients are disposed on the same substrate, the gas generation can be ineffective. With greater than or equal to about 90 wt % of all of the surfactant in the article disposed on a surface of a layer distal from the gas generating layer, gas generation, and thereby foaming, is enhanced.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A foam generating article, comprising:
a first layer comprising a gas generating composition; and
a second layer disposed on a first side of the first layer, wherein the second layer comprises a first surfactant and has a plurality of second layer pores with a second pore size sufficient to form bubbles upon the generation of the gas.

2. The foam generating article of claim 1, wherein the pores have an average diameter of about 0.5 mm to about 10 mm, measured along a major axis.

3. The foam generating article of claim 1, wherein the second layer and the first layer are bonded together by a process selected from the group consisting of point bonding, thermal bonding, ultrasonic bonding, adhesive bonding, and combinations comprising at least one of the foregoing processes.

4. The foam generating article of claim 1, wherein the first layer and the second layer comprise a material individually selected form the group consisting of nonwoven thermoplastic fibers, nonwoven staple fibers, polymeric foams, cellulosic material, and a combination comprising at least one of the foregoing materials.

5. The foam generating article of claim 1, wherein the first layer comprises cellulosic fibers and the second layer comprises polymeric fibers.

6. The foam generating article of claim 1, further comprising a third layer, wherein the third layer comprises a second surfactant and has a plurality of third layer pores with a third pore size sufficient to form bubbles upon the generation of the gas, and wherein the first layer is positioned between the second layer and the third layer.

7. The foam generating article of claim 6, wherein the second layer pores and the third layer pores have an average diameter of about 0.5 mm to about 10 mm, measured along a major axis.

8. The foam generating article of claim 6, wherein the first layer, second layer, and the third layer are bonded together by a process selected from the group consisting of point bonding, thermal bonding, ultrasonic bonding, adhesive bonding, and a combination comprising at least one of the foregoing processes.

9. The foam generating article of claim 6, wherein the first layer, second layer, and third layer comprise a material individually selected form the group consisting of nonwoven thermoplastic fibers, nonwoven staple fibers, polymeric foams, cellulosic material, and a combination comprising at least one of the foregoing materials.

10. The foam generating article of claim 1, further comprising a third layer, wherein the third layer is substantially gas impermeable.

11. The foam generating article of claim 10, further comprising a barrier on a side of the third layer opposite the first layer.

12. The foam generating article of claim 1, wherein the first surfactant is a coating on a side of the second layer opposite the first layer.

13. The foam generating article of claim 1, wherein the first layer comprises a time release agent, and wherein the time release agent enables the gas generating composition to generate gas over a predetermined period of time.

14. The foam generating article of claim 14, wherein the period of time is about 2 minutes to about 10 minutes.

15. The foam generating article of claim 13, wherein the time release agent is a polymer selected from the group consisting of polyacrylate, cellulosic gum, polyurethane, polyoxyalkylene, and combinations comprising at least one of the foregoing time release agents.

16. The foam generating article of claim 15, wherein the time release agent encapsulates at least a portion of the gas generating composition.

17. The foam generating article of claim 1, wherein a second side of the first layer, opposite the first side of the first layer, is substantially gas impermeable such that less than or equal to about 10 wt % of gas generated by the gas generating composition is capable of passing through the second side.

18. The foam generating article of claim 17, wherein the second side comprises a barrier.

19. The foam generating article of claim 1, wherein the first layer further comprises less than or equal to about 5 wt % surfactant, based upon a total combined weight of the surfactant and the gas generating composition in the first layer.

20. A packaged disposable product comprising a foam generating article, comprising:
a first layer comprising a gas generating composition; and
a second layer disposed on a first side of the first layer, wherein the second layer comprises a surfactant;
wherein the first layer comprises less than or equal to about 5 wt % surfactant, based upon a total weight of surfactant and the gas generating composition in the first layer.

21. The product of claim 20, wherein the first layer is an enclosed cavity within the second layer.
